(19) United States
(12) Patent Application Publication
(10) Pub. No.: US 2010/0238872 A1
(43) Pub. Date: Sep. 23, 2010

(54) METHOD FOR TRANSMITTING RESPONSE MESSAGE OF RANDOM ACCESS IN CELLULAR SYSTEM AND METHOD OF RANDOM ACCESS USING THE SAME

(75) Inventors: Jae-Heung Kim, Daejon (KR); Kyoung-Seok Lee, Daejon (KR); Jung-Im Kim, Daejon (KR)

Correspondence Address: LAHIVE & COCKFIELD, LLP;FLOOR 30, SUITE 3000, ONE POST OFFICE SQUARE, BOSTON, MA, 02109, US

(73) Assignees: SAMSUNG ELECTRONICS CO., LTD., Gyeonggi-do (KR); Electronics and Telecommunications Research Institute, Daejon (KR)

(21) Appl. No.: 12/438,524

(22) PCT Filed: Aug. 23, 2007
(86) PCT No.: PCT/KR2007/004040

§ 371 Date: Feb. 23, 2009

(30) Foreign Application Priority Data
Aug. 23, 2006 (KR) 10-2006-0079824

(51) Int. Cl. H04W 4/00

(52) U.S. Cl. 370/329

(57) ABSTRACT

Provided is an asynchronous random access method in a packet-based cellular system, which includes the steps of: receiving a preamble from a mobile station; checking the received preamble to see whether the mobile station includes a mobile station identifier assigned by the base station; when the mobile station does not have a mobile station identifier, allocating first scheduling information to a control information block, allocating a first response message including a mobile station identifier assigned by the base station to a downlink shared channel, and transmitting the control information block and the downlink shared channel to the mobile station; and when the mobile station includes the mobile station identifier, allocating second scheduling information to the control information block, allocating a second response message without the mobile station identifier to the downlink shared channel, and transmitting the control information block and the downlink shared channel to the mobile station.

### TECHNICAL FIELD

The present invention relates to asynchronous random access in a packet-based cellular system; and, more particularly, to a method for transmitting a response message using a least amount of radio resources while minimizing latency, when a response message to asynchronous random access in a base station of a cellular system.

### BACKGROUND ART

In a Wideband Code Division Multiple Access (WCDMA) system, which is the third-generation mobile communication system, a Radio Network Controller (RNC) assigns a Cell Radio Network Temporary Identifier (C-RNTI), which is an identifier of a mobile station, with respect to a random access request from the mobile station. Hereinafter, a random access process in the WCDMA cellular system will be described.

First, a radio interface protocol structure in a WCDMA mobile communication network will be explained to help understanding.

The radio interface protocol of the WCDMA mobile communication network horizontally includes a physical layer, a data link layer, and a network layer, and vertically it includes a user plane for transmitting data and a control plane for delivering control signals, or signaling. The protocol layers are divided into a first layer (L1), a second layer (L2), and a third layer (L3) based on the lower three layers of an Open System Interconnection (OSI) reference model, which is widely known in communication systems.

The physical layer, which is the first layer, provides information transfer service to an upper layer through a physical channel. The physical channel is connected to a Medium Access Control (MAC) layer in the upper part through transport channels. Data is transferred between the MAC layer and the physical layer through the transport channel.

The MAC layer of the second layer, provides a service to a Radio Link Control (RLC) layer, which is an upper layer, through logical channels. The RLC layer of the second layer, supports reliable data transmission, and it may execute a function of segmentation and concatenation of RLC service data unit (SDU) transmitted from the upper layer.

The Radio Resource Control (RRC) layer at the bottom of the third layer is defined only in the control plane. The RRC layer is in charge of controlling the logical channel, the transport channel, and the physical channel with relation to configuration, re-configuration and release of radio bearers.

An initial random access process in the WCDMA mobile communication system will be described hereinafter.

The initial random access is executed through a transport channel and a physical channel for random access in the WCDMA mobile communication system. The physical channel for random access is formed of an uplink preamble channel and a downlink acquisition indication channel (AICH).

A mobile station for random access selects one access slot and one signature and contentiously transmits a preamble to a base station. The preamble is transmitted during an access slot having a predetermined length. The mobile station selects and transmits one among a plurality of signatures during a predetermined initial length of the access slot.

When the base station accurately detects the preamble transmitted from the mobile station, it transmits a response indicator to the mobile station at a predetermined time through the acquisition indication channel, which is a downlink physical channel, by using the signature constituting the preamble. The acquisition indication channel transmits the signature selected by the preamble for a predetermined initial length of an access slot which corresponds to the access slot that the preamble is transmitted. Herein, the base station transmits an acknowledgement (ACK) response or a negative-ACK (NACK) response to the mobile station through the signature transmitted by the acquisition indication channel.

Upon receiving the ACK response through the acquisition indication channel, the mobile station transmits Random Access Channel (RACH) information, which is a random access message, to the base station through a Physical Random Access Channel (PRACH), which is a physical channel. The base station checks the random access message transmitted from the mobile station. Subsequently, the mobile station and the base station transmit and receive control information or data needed for both directions through a channel for data transmission.

When the mobile station executes an initial access procedure, operation related to the connection between the mobile station and the base station is carried out using an RRC establishment procedure. In the perspective of RRC protocol, the procedure is for the mobile station to go from an idle mode to transit to an RRC connection mode. The RRC connection procedure of the mobile station is performed using largely two kinds of control information. To be specific, the RRC connection procedure includes an operation performing transmission/reception as the RRC layer forms a logical channel and an operation transmitting/receiving control primitives from the RRC layer to the MAC layer.

Generally, the logical channel is a channel used to transmit/receive protocol messages between the RRC layers of the mobile station and the base station. The protocol messages are transmitted using a transport channel and a physical channel. The MAC layer or the physical layer do not change the messages and execute operation only involving data transmission.

The logical channel used in the initial random access procedure is a Common Control Channel (CCCH). The mobile station first forms an RRC connection request message and transmits it to the base station through the common control channel. The base station or a control station that has successfully received the RRC connection request message forms an RRC connection setup message and transmits it to the mobile station through the common control channel. After the operation is completed, the mobile station forms an RRC connection setup complete message and transmits it to the base station to notify successful RRC connection. In the RRC connection setup procedure, the control station assigns unique mobile station identifiers, which are C-RNTIs, to mobile stations within the coverage of a base station to identify one from another. Thus, when the base station for a mobile station is change, the mobile station updates its C-RNTI while performing cell update.

The RRC layer of a mobile station transmits a control primitive to the MAC layer of the mobile station by using CMAC (Control Medium Access Control) in addition to the logical channel transmission operation. Accordingly, an environment for controlling a transport channel and a physical channel is set up. In other words, the RRC layer of the mobile station requests the MAC layer to execute a random access procedure using a CMAC-CONFIG-Req primitive in the initial random access procedure.

Accordingly, the initial random access procedure of the mobile station is completed as the common control signal is formed and transmitted in the RRC layer and the control primitive is formed and transmitted to the MAC layer.

Assignment of the mobile station identifier (ID) is important in the RRC connection procedure of the mobile station. Although the mobile station stores a Temporary Mobile Station Identifier (TMSI) or an International Mobile Subscriber Identifier (IMSI) and operates, the mobile station needs to have a C-RNTI and a UTRAN-Radio Network Temporary Identifier (U-RNTI) assigned thereto to access to the base station and transmit/receive data. The C-RNTI and the U-RNTI are used for the base station to identify the mobile station. They form the ID information of the mobile station and they are needed to manage position information of the mobile station and page the mobile station in the base station. Under the RRC connection, the base station and the mobile station sustain the ID information.

In the initial random access procedure, a mobile station is identified through connection establishment. In other words, when the mobile station transmits an RRC connection request message to the base station, the RRC layer of the base station receives the RRC connection request message, assigns a C-RNTI, which is a mobile station identifier, to the mobile station, adds the C-RNTI to an RRC connection setup message, and transmits the RRC connection setup message with the C-RNTI to the mobile station. The RRC layer of the mobile station receives the RRC connection setup message, analyzes the message and identifies the C-RNTI assigned to the mobile station, and informs the MAC layer of the C-RNTI.

On the contrary, a packet-based Long-Term Evolution (LTE) system on which researchers are working on standardization to provide diverse packet services, aims to provide only packet services. The researchers are studying to utilize radio resources more efficiently and variably in the system. Differently from conventional systems, mobile station identifiers are assigned not by the control station but by a base station in the LTE system. Also, the LTE system is expected to have minimal call setup latency by simplifying the asynchronous random access procedure and complete the asynchronous random access procedure using a least amount of radio resources.

Further, it is requested to effectively perform random access between a target base station and a mobile station to process handover.

### DETAILED DESCRIPTION OF THE PRESENT INVENTION

An embodiment of the present invention is directed to providing a response message transmitting method that can assign and manage mobile station identifiers using a least amount of radio resources and reduce random access latency in asynchronous random access procedure that is executed for a mobile station to access to a base station in a packet-based cellular system.

Another embodiment of the present invention is directed to providing a random access method employing the method for transmitting response messages for random access.

Another embodiment of the present invention is directed to providing a random access method for performing effective random access between a target base station and a mobile station to process handover of the mobile station.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

In accordance with an aspect of the present invention, there is provided a method for transmitting a response message for random access in a base station of a packet-based cellular system, including the steps of: a) receiving a preamble from a mobile station; b) checking the received preamble to see whether the mobile station includes a mobile station identifier assigned by the base station; c) when the mobile station does not have a mobile station identifier, allocating first scheduling information to a control information block, allocating a first response message including a mobile station identifier assigned by the base station to a downlink shared channel, and transmitting the control information block and the downlink shared channel to the mobile station; and d) when the mobile station includes the mobile station identifier, allocating second scheduling information to the control information block, allocating a second response message without the mobile station identifier to the downlink shared channel, and transmitting the control information block and the downlink shared channel to the mobile station.

In accordance with another aspect of the present invention, there is provided a method for transmitting a response message for random access in a base station of a packet-based cellular system, which includes the steps of: a) receiving a preamble from a mobile station; b) checking the received preamble to see whether the mobile station includes a mobile station identifier assigned by the base station; c) when the mobile station does not have a mobile station identifier, allocating scheduling information to a control information block, allocating a first response message including a mobile station identifier assigned by the base station to a downlink shared channel, and transmitting the control information block and the downlink shared channel to the mobile station; and d) when the mobile station includes the mobile station identifier, allocating a second response message without the mobile station identifier to the control information block, and transmitting the control information block to the mobile station.

In accordance with another aspect of the present invention, there is provided a random access method in a packet-based cellular system, which includes the steps of: a) receiving a preamble from a mobile station; b) checking the received preamble to see whether the mobile station includes a mobile station identifier assigned by the base station; c) when the mobile station does not have a mobile station identifier, allocating first scheduling information to a control information block, allocating a first response message including a mobile station identifier assigned by the base station to a downlink shared channel, and transmitting the control information block and the downlink shared channel to the mobile station; d) when the mobile station includes the mobile station identifier, allocating second scheduling information to the control information block, allocating a second response message without the mobile station identifier to the downlink shared channel, and transmitting the control information block and the downlink shared channel to the mobile station; and e) after the step d), receiving the mobile station identifier included in the mobile station from the mobile station by using uplink shared channel information included in the second response message.

In accordance with another aspect of the present invention, there is provided a random access method in a packet-based cellular system, which includes the steps of: a) receiving a preamble from a mobile station; b) checking the received preamble to see whether the mobile station includes a mobile station identifier assigned by the base station; c) when the mobile station does not have a mobile station identifier, allocating scheduling information to a control information block, allocating a first response message including a mobile station identifier assigned by the base station to a downlink shared channel, and transmitting the control information block and the downlink shared channel to the mobile station; d) when the mobile station includes the mobile station identifier, allocating a second response message without the mobile station identifier to the control information block, and transmitting the control information block to the mobile station; and e) after the step d), receiving the mobile station identifier included in the mobile station from the mobile station by using uplink shared channel information included in the second response message.

In accordance with another aspect of the present invention, there is provided a random access method of a mobile station for handover in a packet-based cellular system, which includes the steps of: a) when a target base station receives a handover request from a source base station, allocating a sequence index of a preamble to be used by the mobile station for random access; b) at the target base station, pre-allocating a radio resource for handover of the mobile station; c) at the target base station, transmitting the sequence index of the allocated preamble to the mobile station through the source base station; d) at the target base station, receiving a preamble from the mobile station; and e) when the received preamble is the same as the sequence index of the preamble allocated for handover, transmitting a response message including the pre-allocated radio resource to the mobile station.

The advantages, features and aspects of the invention will become apparent from the following description of the embodiments with reference to the accompanying drawings, which is set forth hereinafter. Also, when it is considered that detailed description on a relate art may unnecessarily obscure the point of the present invention, the description will not be provided herein. Herein, specific embodiment of the present invention will be described with reference to the accompanying drawings.

The 3rd Generation Partnership Project (3GPP), which is a group for standardization, is discussing on a Long Term Evolution (LTE) system. The LTE system is a technology for realizing a packet-based communication at high speed of about 100 Mbps, and it is expected to be commercialized by 2010. Current packet-based cellular system, e.g., an LTE system, employs an Orthogonal Frequency Division Multiple Access (OFDMA) scheme. Differently from a CDMA system which identifies radio resources for each mobile station by allocating a code, an OFDMA system has radio resources of a two-dimensional structure, which is formed of frequency and time. In short, in the OFDMA system, radio resources of a downlink physical channel and an uplink physical channel are formed of time and frequency. The radio resources use radio resource blocks formed of a Transmission Time Interval (TTI) in time and sub-carrier groups in frequency. Radio frames constituting the radio resources are formed of slots (or TTI) having a size of about 0.5 millisecond. Thus, a radio frame of 10 milliseconds is formed of 20 slots.

Random access is largely divided into two types according to usage conditions in a packet-based cellular system. To be specific, one is an asynchronous (or initial) random access performed when the physical layer of a mobile station is not synchronized with the physical layer of a base station or when an idle-state mobile station tries to access to a base station. The other is a synchronized random access performed when a mobile station requests an uplink shared channel in an active state where the mobile station transmits/receives data to/from the base station. The active state means a state that uplink physical layers are synchronized and maintained.

Radio resources for asynchronous random access in an uplink radio frame may be disposed in a fixed slot of the radio frame, for example, the first slot or the last slot. The unit for the radio resources for asynchronous random access is formed of BW_{RA} indicating the size of a sub-carrier group on a frequency axis and T_{RA} indicating a symbol size on a time axis. The T_{RA} indicating a symbol size on the time axis may be allocated with one slot or a plurality of slots. A random access (RA) burst, which is a unit of radio resources for asynchronous random access may be formed of a preamble in the form of signature. The preamble forming random access burst should have an auto-correlation characteristic and a cross-correlation characteristic.

Mobile stations randomly select one random access burst area among random access burst areas within an uplink shared channel allocated by the base station for asynchronous random access, randomly select a certain sequence (or index) for the preamble of random access burst, and transmit the sequence.

The base station can classify and use the pattern of a sequence forming the preamble of the random access burst for asynchronous random access according to the reason for the asynchronous random access. To be specific, information like the reason for asynchronous random access may be indicated differently according to how the random access burst is formed. When the random access burst is formed of preamble only, the base station includes the information classifying the pattern of the sequence constituting the preamble differently by the base station according to the reason for asynchronous random access in system information and broadcasts the system information. Accordingly, the mobile stations transmit different sequence patterns according to the reason for asynchronous random access by using sequence pattern setup information and the reason for asynchronous random access within the system information broadcasted by the base station. Herein, the sequence pattern may be represented as the index of sequence.

The reason for asynchronous random access includes initial access, handover, synchronization acquisition of uplink physical layers (in case of a mobile station with a mobile station identifier assigned thereto), a state transition of a mobile station from the idle state and the active state, tracking area (TA) update, and emergency call.

The response information for asynchronous random access that the base station receiving the random access burst for asynchronous random access from the mobile station should transmit to downlink may include one or more among downlink shared channel position information, a mobile station identifier, uplink shared channel position information, a preamble index, ACK/negative-ACK (NACK) information, timing advanced information, power level information, and frequency level information.

Herein, the downlink shared channel position information denotes position of a downlink shared channel allocated for an asynchronous random access response. The mobile station can access to random access response information by using the downlink shared channel position information.

Generally, mobile stations in the idle state do not have the mobile station identifier that is uniquely recognized by a scheduler of a base station in a cell. Accordingly, when a mobile station without the mobile station identifier that can be recognized by the scheduler of the base station attempts the asynchronous random access, the base station assigns a mobile station identifier to the mobile station. The mobile station identifier is mobile station identifier information assigned by the base station.

The uplink shared channel position information is information addressing an uplink shared channel that can be used by a mobile station attempting the asynchronous random access. The preamble sequence index is the index of sequence used by the mobile station attempting the asynchronous random access.

The ACK/NACK information is information on whether the base station has received the preamble sequences of the mobile stations attempting the asynchronous random access. When the base station has successfully detected the preamble sequence transmitted from a certain mobile station, it may set an ACK value of ‘1’. The base station may set a NACK value of ‘0’, when it has successfully received the preamble for asynchronous random access but the received preamble signal is too high or there is no appropriate radio resources available to be allocated.

The timing advanced information is timing information that needs to be adjusted for the mobile station to acquire uplink physical layer synchronization by reducing timing offset which is estimated by the base station by using the preamble sequence information when the mobile station attempts the asynchronous random access.

The power level information is needed for the mobile station to set up a power level to be used when it transmits to the uplink a power level which is estimated by the base station by using the preamble sequence information when the mobile station attempts the asynchronous random access.

The frequency level information is information on frequency adjustment needed for the mobile station to transmit signals to the uplink using a frequency drift value which is estimated by the base station using the preamble sequence information when the mobile station attempts the asynchronous random access.

Meanwhile, in the packet-based cellular system, a mobile station may not maintain uplink synchronization to perform power-saving operation in the RRC connected state in which the mobile station includes a mobile station identifier assigned thereto. To transmit information to the uplink in the state that the uplink synchronization is not maintained, the mobile station should execute the asynchronous random access procedure first. Also, researchers are studying a handover method of assigning a mobile station identifier in advance to the mobile station attempting the handover in the base station of the target cell and transmitting the mobile station identifier of the target cell to the mobile station before the mobile station executes asynchronous random access to the target cell. Therefore, there is a case that a base station assigns a mobile station identifier to a mobile station before the mobile station performs asynchronous random access.

FIG. 1 illustrates an initial asynchronous random access procedure.

A mobile station selects a radio resource area for random access and randomly selects one sequence among a plurality of preamble sequences and contentiously transmits a random access preamble to a base station in step S11. Herein, the random access preamble may be classified and allocated according to an asynchronous random access reason (or priority order). Thus, the mobile station selects a different sequence according to a case where it has a mobile station identifier assigned thereto or a case where it does not have a mobile station identifier assigned thereto, forms the preamble, and transmits the preamble to a base station. In other words, the base station allocates some sequences among a plurality of sequences so that mobile stations with a mobile station identifier can use the sequences when they attempts asynchronous random access, and informs the mobile stations of such information. The mobile stations select different sequences according to whether the mobile station includes a mobile station identifier assigned thereto, and form preambles.

The base station detects random access preamble sequences transmitted from the mobile stations and analyses the detected preambles. The base station forms different response messages according to whether a corresponding mobile station has a mobile station identifier, which can be known from the detected preamble, and transmits the response messages to the mobile stations in step S12. The process that the base station forms the response message differently according to whether a corresponding mobile station has a mobile station identifier will be described later, with reference to FIGS. 2 to 4.

When a mobile station receives a response message for random access from the base station, it checks out the response message, and if it is an ACK message, it transmits an RRC connection request message to the RRC layer of the base station in step S13. When the RRC layer of the base station receives the RRC connection request message from the mobile station, it checks the received RRC connection request message and transmits an RRC connection response message to the mobile station in step S14.

FIG. 2 illustrates a radio resource allocation structure for transmitting a response message for random access in accordance with an embodiment of the present invention.

A control information block 21 is a radio resource block for transmitting control information 22 including scheduling information for downlink radio resources and an uplink radio resources. To be specific, the control information block 21 signifies a radio resource for transmitting signaling information of a physical layer (which is the first layer) and a Medium Access Control (MAC) layer (which is the second layer). The control information 22 may includes a mobile station identifier, position information of an allocated radio resource block, and a transmission format. Herein, the mobile station identifier is an identifier uniquely assigned by a base station to each mobile station or a group identifier pre-assigned by the base station for a specific purpose. The radio resource block position information is information for addressing radio resources of an OFDMA system divided into frequency and time axes. The transmission format information includes a modulation scheme used for the allocated radio resource among many modulation schemes, such as Quadrature Phase Shift Keying (QPSK), 16QAM, and 64QAM, and payload size information (or encoding level information) and it calculates an encoding level by informing the size of payload to be transmitted to the allocated radio resource or directly informs the encoding level.

A response message for random access may be transmitted through a downlink shared channel (DL-SCH) 23. In other words, the base station locally or destributively allocates response messages for random access to the downlink shared channel 23. Herein, local allocation is a method of allocating information to be transmitted to a specific mobile station to specific consecutive sub-carrier indexes and transmitting it. The distributed allocation is a method of destributively allocating the information to be transmitted to a specific mobile station to sub-carrier indexes having a predetermined interval and transmitting it.

With reference to FIGS. 3 and 4, a response message transmitting method for random access will be described in detail according to the present invention.

FIG. 3 is a flowchart describing a procedure for transmitting response messages for random access in a base station in accordance with an embodiment of the present invention.

Both the base station and the mobile station are aware of preamble sequences used when the mobile station already includes its mobile station identifier assigned thereto. In other words, preamble sequences used among a plurality of preamble sequences when a mobile station having its mobile station identifier attempts random access are already allocated, and when a mobile station already includes its mobile station identifier assigned thereto, it forms a random access preamble by selecting one among the pre-allocated preamble sequences or using a preamble sequence allocated by the base station and transmits the random access preamble to the base station. Accordingly, the base station can know whether the mobile station already includes a mobile station identifier or not from the random access preamble transmitted from the mobile station.

The mobile station selects a different preamble sequence according to whether it has a mobile station identifier assigned thereto and transmits a random access preamble to the base station.

The base station receives the random access preamble from the mobile station in step S5301, and analyzes the received random access preamble in step S5302. Through this process, the base station can recognize whether the mobile station has a mobile station identifier assigned thereto when it has attempted the random access or whether the mobile station does not have a mobile station identifier assigned thereto when it has attempted the random access.

When the base station does not have a mobile station identifier assigned thereto when it has attempted the random access, the base station assigns a scheduling identifier A to a control information block and allocates block position information of a downlink shared channel for receiving a random access response message to the control information block. Then, the base station allocates a response message for random access, which is a grant message, to the allocated downlink shared channel (DL-SCH) in step S5304.

Herein, the scheduling identifier A is pre-assigned by the base station to identify each mobile station, when a mobile station without a mobile station identifier assigned thereto tries random access. The mobile station is already aware of the scheduling identifier A and it recognizes from the scheduling identifier A that what is received is a response message for random access transmitted to mobile stations without a mobile station identifier assigned thereto.

Also, when the mobile station identifier is not assigned, the response message for random access may include a mobile station identifier (e.g., a scheduling identifier), uplink shared channel position information, a preamble index, and timing advanced information. Herein, the mobile station identifier is a unique identifier of the mobile station that is assigned by the base station to the mobile station, such as a scheduling identifier or a MAC identifier. The uplink shared channel position information is information addressing an uplink shared channel allocated by the base station so that additional information on the mobile station that has attempted the random access can be transmitted to the uplink. The preamble index is an index of preamble sequence used by the mobile station that has attempted the random access, and it is information for identifying the mobile station that has attempted the random access. The timing advanced information is information for adjusting transmission timing to maintain orthogonal property with the other mobile stations within the coverage of the base station, when the mobile station transmits information to the uplink.

In step S5306, the base station transmits a response message for random access on the basis of a transmission period through the allocated radio resources. A mobile station checks the information of the control information block first and checks a scheduling identifier and allocated shared channel block position information. In short, when a scheduling identifier A is allocated in the control information block, it recognizes that what is received is a response message for random access attempted by a mobile station without a mobile station identifier, and checks downlink shared block position information for a response message. The mobile station demodulates and decodes the data transmitted through the allocated downlink shared channel and acquires the response message for random access.

The mobile station checks whether the preamble index included in the acquired response message is the same as the sequence index of the preamble that it has transmitted. When the indexes are the same, the mobile station checks the mobile station identifier (e.g., the scheduling identifier) in the response message, and transmits its information, such as RRC connection information to the uplink by using the uplink shared channel block position information allocated thereto. Herein, the mobile station can adjust uplink timing synchronization by using the timing advanced information in the response message. If necessary, the response message may include frequency level information or power level information to properly transmit information to the uplink. The mobile station can set up proper power level and frequency based on the frequency level information and the power level information during the uplink transmission.

Meanwhile, when it turns out that the mobile station has attempted random access in the state that it has a mobile station identifier assigned thereto in step S5303, in step S5305, it allocates a scheduling identifier B to the control information block and allocates downlink shared channel block position information for receiving a response message for random access to a control information block. Then, the base station allocates a response message for random access, which is a grant message, to the allocated downlink shared channel.

Herein, when the scheduling identifier B is pre-assigned by the base station to identify mobile stations one from another when the mobile station with a mobile station identifier assigned thereto tries random access. Since the mobile station is already aware of the scheduling identifier B, it recognizes from the scheduling identifier B that what is received is a response message for random access which is transmitted to mobile stations with a mobile station identifier assigned thereto.

When the mobile station already includes a mobile station identifier assigned thereto, the response message for random access needs not include any mobile station identifier, e.g., a scheduling identifier. Thus, when the mobile station has its mobile station identifier assigned thereto, the response message may include uplink shared channel position information, a preamble index, timing advanced information.

In step S5306, the base station transmits the response message for random access to the mobile station through the allocated radio resource at a transmission period.

Mobile stations examine the information of the control information block and check the scheduling identifier and the allocated shared channel block position information. In other words, when the scheduling identifier B is allocated to the control information block, the mobile stations recognize that what is received is a response message for random access attempted by a mobile station with a mobile station identifier assigned thereto, and check the allocated downlink shared channel position information for the response message. The mobile stations demodulate and decode data transmitted through the allocated downlink shared channel and acquire the response message for random access.

The mobile stations check whether the preamble index included in the acquired response message is the same as the sequence index of the preamble that they have transmitted. The mobile stations transmit its information, such as RRC connection information, to the uplink by using the uplink shared channel block position information allocated to them, when the indexes are the same. Herein, the mobile station may adjust timing synchronization of the uplink by using the timing advanced information within the response message.

Meanwhile, when a mobile station includes a mobile station identifier, it is possible for the base station not to transmit a response message through the downlink shared channel and transmit the response message through a control information block. This will be described below with reference to FIG. 4.

In step S401, when the base station receives the preamble of a random access burst, the preamble of the random access burst is analyzed in step S402. This process teaches the mobile station whether the mobile station has attempted random access in the state with or without a mobile station identifier assigned thereto.

When it turns out that the mobile station has attempted the random access with a mobile station identifier assigned thereto, in step S404, the base station checks whether a current downlink shared channel is available. When it turns out that it is difficult to allocate a downlink shared channel for transmitting a response message for random access or that it is easy to transmit a response message for random access to the control information block, the base station transmits a response message except a mobile station identifier, which is a random access grant message in step S405, and transmits the random access grant message to the mobile station in step S406. In this case, the random access grant message may include uplink shared channel block position information, a preamble index, and timing advanced information.

The mobile station examines the control information block, and checks whether the preamble index included in the control information block is the same as the sequence index of the preamble that that mobile station has transmitted. When the indexes are the same, the mobile station transmits its information, such as RRC connection information, to the uplink by using uplink shared channel block position information allocated thereto. Herein, the mobile station may adjust timing synchronization of the uplink by using the time advanced information.

As described above, when the mobile station have a mobile station identifier assigned thereto, the response message for random access does not include the mobile station identifier assigned by the base station. Therefore, the base station needs to go through a process for recognizing a mobile station identifier that is already assigned to a mobile station. There are two methods for the base station to receive a mobile station identifier from the mobile station.

A first one is a method of receiving a mobile station identifier assigned by the base station from the mobile station through an uplink shared channel (UL-SCH) included in the response message, after the base station has transmitted a response message to the mobile station attempting random access. In other words, the mobile station receives a response message from the base station and, when it detects the uplink shared channel allocated thereto, it transmits the mobile station identifier that is already assigned thereto to the base station through the allocated uplink shared channel.

The second one is a method of allocating a preamble sequence index of a random access burst for random access to be attempted by the mobile station, while the base station assigns a mobile station identifier during handover. In other words, the base station recognizes a mobile station identifier based on the preamble transmitted from the mobile station, as the base station allocates (or performs scheduling on) a preamble sequence index to be used by a mobile station with a mobile station identifier already assigned thereto, and the mobile station attempts random access using a preamble sequence index allocated by the base station. In this case, the mobile station needs not transmit the mobile station identifier already assigned thereto through the uplink shared channel to the base station.

Meanwhile, a random access method of a mobile station during handover will be described hereafter.

First, a mobile station transmits a handover request message to a source base station when it needs to perform handover. The source base station checks a target base station and requests the target base station to process handover.

The target base station allocates a preamble sequence index to be used by the mobile station to perform random access to the target base station and, at the same time, reserves a radio resource for the handover, and transmits the preamble sequence index to be used by the mobile station to the source base station.

Accordingly, the source base station transmits the preamble sequence index allocated by the target base station to the mobile station. Herein, the source base station may transmit the preamble sequence index allocated by the target base station to the mobile station by using downlink control signals, which are L1/L2 control signals, or by using a downlink shared channel.

The mobile station forms a preamble by using the preamble sequence index allocated by the target base station to perform the random access for handover, and attempts random access to the target base station.

When the target base station receives the preamble form the mobile station, it checks whether the sequence index included in the preamble is the same as the preamble sequence index allocated before for the handover. When it is not the preamble sequence index allocated before for the handover, the target base station executes a general random access procedure. When it is the preamble sequence index allocated before for the handover, the target base station transmits a response message including a mobile station identifier pre-assigned for the handover to the mobile station.

Subsequently, the mobile station transmits information to the target base station by using the information included in the response message transmitted from the target base station.

Meanwhile, the method of the present invention described above may be authored as a computer program, and the codes and/or code segments of the program may be easily inferred by a computer programmer of an art to which the present invention pertains. Also, the program may be stored in a computer-readable recording medium, or a data storage, and read and executed by a computer. The recording medium includes all forms of recording media that can be run on a computer.

While the present invention has been described with respect to certain preferred embodiments, it will be apparent to those skilled in the art that various changes and modifications may be made without departing from the scope of the invention as defined in the following claims.

### BRIEF DESCRIPTION OF THE DRAWINGS

FIG. 1 illustrates a typical initial asynchronous random access method.

FIG. 2 illustrates a radio resource allocation structure for transmitting a response message for random access in accordance with an embodiment of the present invention.

FIG. 3 is a flowchart describing a procedure for transmitting response messages for random access in a base station in accordance with an embodiment of the present invention.

FIG. 4 is a flowchart describing a procedure for transmitting response messages for random access in a base station in accordance with another embodiment of the present invention.

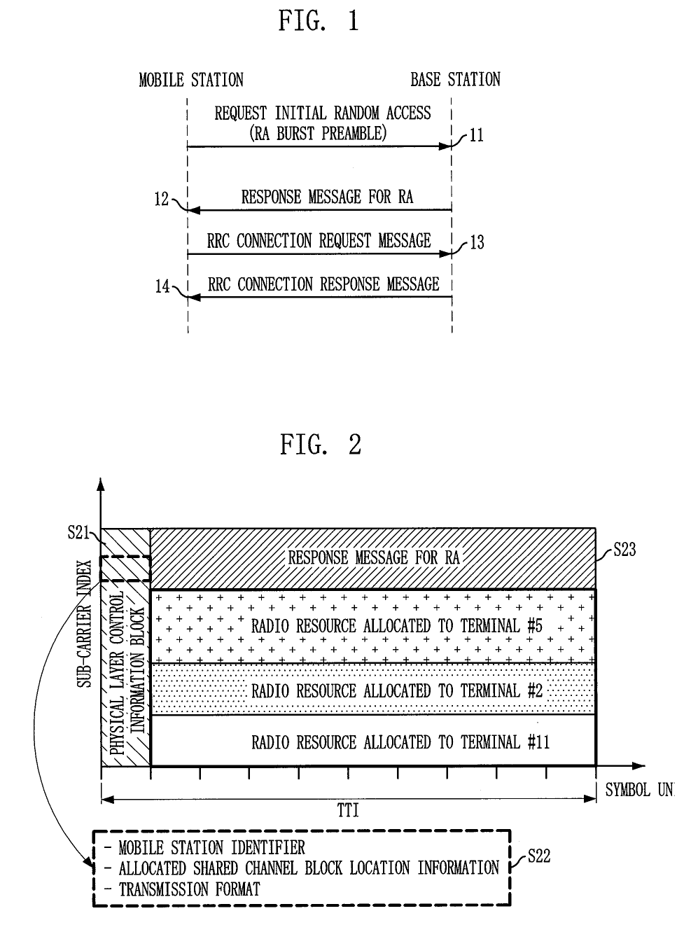

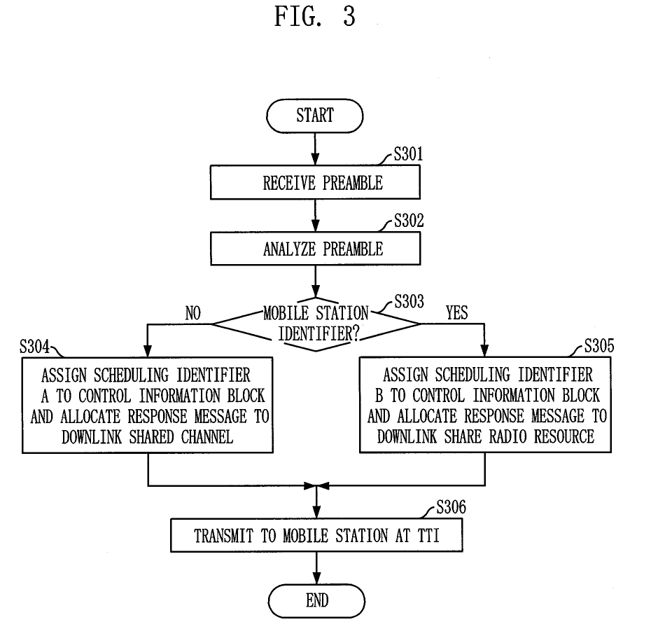

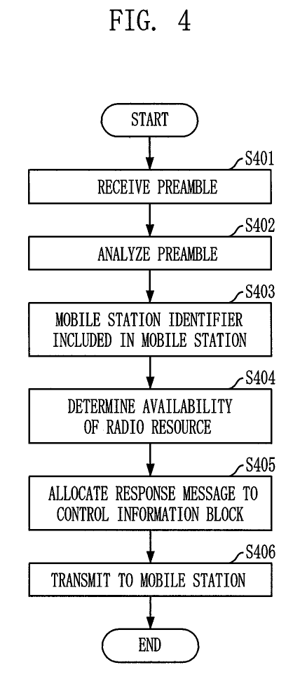

### INDUSTRIAL APPLICABILITY

According to the method of the present invention described above, a base station can transmit response messages on the range of available radio resources and whether a mobile station has a mobile station identifier by using a least amount of radio resources and minimize latency following random access in an asynchronous random access procedure that is performed for the mobile station to access to the base station in a packet-based cellular system.

Also, according to the method of the present invention, random access can be performed using a least amount of radio resources without latency in a handover process of the mobile station, as the base station predetermines an index of a preamble sequence to be used by the mobile station and transmits the index to the mobile station through a source base station, and the mobile station tries random access to a target base station using the preamble sequence index.

What is claimed is:

1. A method for transmitting a response message for random access in a base station of a packet-based cellular system, comprising the steps of:
a) receiving a preamble from a mobile station;
b) checking the received preamble to see whether the mobile station includes a mobile station identifier assigned by the base station;
c) when the mobile station does not have a mobile station identifier, allocating first scheduling information to a control information block, allocating a first response message including a mobile station identifier assigned by the base station to a downlink shared channel, and transmitting the control information block and the downlink shared channel to the mobile station; and
d) when the mobile station includes the mobile station identifier, allocating second scheduling information to the control information block, allocating a second response message without the mobile station identifier to the downlink shared channel, and transmitting the control information block and the downlink shared channel to the mobile station.

2. The method of claim 1, wherein the first scheduling information includes a first scheduling identifier pre-allocated by the base station, and information of the downlink shared channel which is allocated to the response message.

3. The method of claim 1, wherein the second scheduling information includes a second scheduling identifier pre-allocated by the base station, and information of the downlink shared channel which is allocated to the response message.

4. The method of claim 1, wherein, in the step b), the base station uses a different sequence index according to whether the mobile station includes the mobile station identifier, and
the base station checks whether the mobile station includes the mobile station identifier based on the sequence index of the received preamble transmitted from the mobile station.

5. The method of claim 1, wherein the first response message includes at least the mobile station identifier assigned by the base station, uplink shared channel position information allocated by the base station, and information on a preamble index used by the mobile station during random access.

6. The method of claim 1, wherein the second response message includes at least uplink shared channel position information allocated by the base station, and information on a preamble index used by the mobile station during random access.

7. A method for transmitting a response message for random access in a base station of a packet-based cellular system, comprising the steps of:
a) receiving a preamble from a mobile station;
b) checking the received preamble to see whether the mobile station includes a mobile station identifier assigned by the base station;
c) when the mobile station does not have a mobile station identifier, allocating scheduling information to a control information block, allocating a first response message including a mobile station identifier assigned by the base station to a downlink shared channel, and transmitting the control information block and the downlink shared channel to the mobile station; and
d) when the mobile station includes the mobile station identifier, allocating a second response message without the mobile station identifier to the control information block, and transmitting the control information block to the mobile station.

8. The method of claim 7, wherein, in the step b), the base station uses a different sequence index according to whether the mobile station includes the mobile station identifier, and
the base station checks whether the mobile station includes the mobile station identifier based on a sequence index of the received preamble transmitted from the mobile station.

9. The method of claim 7, wherein the second response message includes at least uplink shared channel position information allocated by the base station, and information on a preamble index used by the mobile station during random access.

10. A random access method in a packet-based cellular system, comprising the steps of:
a) receiving a preamble from a mobile station;
b) checking the received preamble to see whether the mobile station includes a mobile station identifier assigned by the base station;
c) when the mobile station does not have a mobile station identifier, allocating first scheduling information to a control information block, allocating a first response message including a mobile station identifier assigned by the base station to a downlink shared channel, and transmitting the control information block and the downlink shared channel to the mobile station;
d) when the mobile station includes the mobile station identifier, allocating second scheduling information to the control information block, allocating a second response message without the mobile station identifier to the downlink shared channel, and transmitting the control information block and the downlink shared channel to the mobile station; and
e) after the step d), receiving the mobile station identifier included in the mobile station from the mobile station by using uplink shared channel information included in the second response message.

11. A random access method in a packet-based cellular system, comprising the steps of:
a) receiving a preamble from a mobile station;
b) checking the received preamble to see whether the mobile station includes a mobile station identifier assigned by the base station;
c) when the mobile station does not have a mobile station identifier, allocating scheduling information to a control information block, allocating a first response message including a mobile station identifier assigned by the base station to a downlink shared channel, and transmitting the control information block and the downlink shared channel to the mobile station;
d) when the mobile station includes the mobile station identifier, allocating a second response message without the mobile station identifier to the control information block, and transmitting the control information block to the mobile station; and
e) after the step d), receiving the mobile station identifier included in the mobile station from the mobile station by using uplink shared channel information included in the second response message.

12. A random access method of a mobile station for handover in a packet-based cellular system, comprising the steps of:
a) when a target base station receives a handover request from a source base station, allocating a sequence index of a preamble to be used by the mobile station for random access;
b) at the target base station, pre-allocating a radio resource for handover of the mobile station;
c) at the target base station, transmitting the sequence index of the allocated preamble to the mobile station through the source base station;
d) at the target base station, receiving a preamble from the mobile station; and
e) when the received preamble is the same as the sequence index of the preamble allocated for handover, transmitting a response message including the pre-allocated radio resource to the mobile station.
